(19) United States
(12) Patent Application Publication
(10) Pub. No.: US 2015/0113372 A1
(43) Pub. Date: Apr. 23, 2015

(54) TEXT AND SHAPE MORPHING IN A PRESENTATION APPLICATION

(71) Applicant: APPLE INC., Cupertino, CA (US)

(72) Inventor: Mark J. Flider, Mountain View, CA (US)

(73) Assignee: APPLE INC., Cupertino, CA (US)

(21) Appl. No.: 14/057,808

(22) Filed: Oct. 18, 2013

(51) Int. Cl. G06T 13/80; G06F 17/21

(52) U.S. Cl. CPC G06T 13/80; G06F 17/214
USPC 715/204

(57) ABSTRACT

Character morphing between slides of a presentation is disclosed. In certain implementations, Characters with varying styles within separate slides are matched and can be animated during slide transitions using distance field morphing. In certain embodiments, this involves matching characters on both an outgoing and incoming slide and providing a morphing process in order to smoothly transition from the outgoing slide to the incoming slide. Additionally, different techniques may be provided along with the distance field morph to further improve the slide transition process.

### BACKGROUND

The present disclosure relates generally to morphing text of different styles or arbitrary shapes with clearly-defined borders on sequential screens, such as on sequential slides of a slideshow presentation.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

In the presentation of information to an audience, a presentation application implemented on a computer or other electronic device is commonly employed. For example, it is not uncommon for various types of public speaking, (such as lectures, seminars, classroom discussions, speeches, and so forth), to be accompanied by computer generated presentations that emphasize or illustrate points being made by the speaker. Such presentations may include music, sound effects, images, videos, text passages, numeric examples or spreadsheets, charts, graphs, or audiovisual content that emphasizes points being made by the speaker.

Typically, these presentations are composed of “slides” that are sequentially presented in a specified order and which each contain objects of various types that help convey the information to be presented. Conventionally, to transition between slides, a first slide would be replaced by a second slide on the screen. In such transitions some level of animation or some type of effect may be employed, but typically little thought is given to the individual objects on each slide. Instead, in the simplest implementations, each slide may instead be treated as a static object. Due to the prevalence of such computer-generated and facilitated presentations, one challenge is to maintain the interest level generated by such presentations, i.e., to keep the audience interested in the material being presented on the screen.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present disclosure generally relates to techniques for providing object-aware transitions between slides of a presentation. Such object-aware transitions may include identifying matched text characters or arbitrary shapes on sequentially presented slides, where possible. In one embodiment, such matching may be implemented using a matching function or algorithm. For example, in one embodiment, matched objects are identified by comparing text character shapes or text character input codes. Once identified, the matched text characters or shapes may be transitioned using a morphing process. For example, matched text characters may remain displayed during the transition, being animated from how they appear on the outgoing slide to how they appear on the incoming slide. Conversely, unmatched text characters may be removed from or brought into view as the slide transition occurs.

Further, if there is a difference in text character style (e.g., font, emphasis, size, etc.) between a text character of a first slide and the same text character of a second slide, a text morph based on morphing a pair of distance fields of the text characters from the first slide to the second slide creates a slide transition animation. The text morph using distance fields provides a useful path for a transition between two fonts, which prior developments in slide transition animation did not adequately address.

### BRIEF DESCRIPTION OF THE DRAWINGS

Various aspects of this disclosure may be better understood upon reading the following detailed description and upon reference to the drawings in which:

FIG. 1 is a block diagram of an electronic device that may use the techniques disclosed herein, in accordance with aspects of the present disclosure;

FIG. 2 is a front view of a handheld device, such as an iPhone® by Apple Inc., representing an example of the electronic device of FIG. 1;

FIG. 3 is a front view of a tablet device, such as an iPad® by Apple Inc., representing an example of the electronic device of FIG. 1;

FIG. 4 is a perspective view of a notebook computer, such as a MacBook Pro® by Apple Inc., representing an example of the electronic device of FIG. 1;

FIG. 5 illustrates an edit mode screen of a presentation application, in accordance with aspects of the present disclosure;

FIG. 6 depicts an outgoing slide with outgoing text and an incoming slide with incoming text in a slideshow presentation application, in accordance with aspects of the present disclosure;

FIG. 7 depicts an example of control flow logic implemented as an algorithm for determining matching text, in accordance with aspects of the present disclosure;

FIG. 8 depicts an example of control flow logic implemented as an algorithm for creating a text morph slide transition animation, in accordance with aspects of the present disclosure;

FIG. 9 depicts a step by step process of creating a distance field for an outgoing text character and an incoming text character, in accordance with aspects of the present disclosure;

FIG. 10A depicts an outgoing text character string prior to undergoing a gradual transition from an outgoing text character string style to an incoming text character string style during a slide transition, in accordance with aspects of the present disclosure;

FIG. 10B depicts a morphing text character string toward a beginning of the gradual transition from the outgoing text character string style to the incoming text character string style during the slide transition, in accordance with aspects of the present disclosure;

FIG. 10C depicts the morphing text character string toward an end of the gradual transition from the outgoing text character string style to the incoming text character string style during the slide transition, in accordance with aspects of the present disclosure; and

FIG. 10D depicts an incoming text character string after undergoing the gradual transition from the outgoing text character string style to the incoming text character string style during the slide transition, in accordance with aspects of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The disclosure is generally directed to morphing text of different styles or arbitrary shapes (with one or both of the interior or exterior borders being clearly defined) between slides of a presentation. In particular, in accordance with certain implementations, similar text characters with differing text character styles within each slide are matched and can be separately and independently handled during slide transitions as compared to unmatched text characters. In certain embodiments, this involves matching text characters on both an outgoing and incoming slide and providing specific text morphing animation for those matched text characters. While slides and slideshow presentations in the context of a presentation are generally described in the present examples, it should be appreciated that such examples are employed merely to provide context and to thereby facilitate explanation of the present approaches. As will be appreciated, the present text morphing techniques may be employed in various other contexts where text of different styles may be employed and where an animated transition may be desired between the appearance of text at one time and the appearance of a corresponding text string at a later time. With this in mind, examples of suitable devices for use in accordance with the present disclosure are as follows.

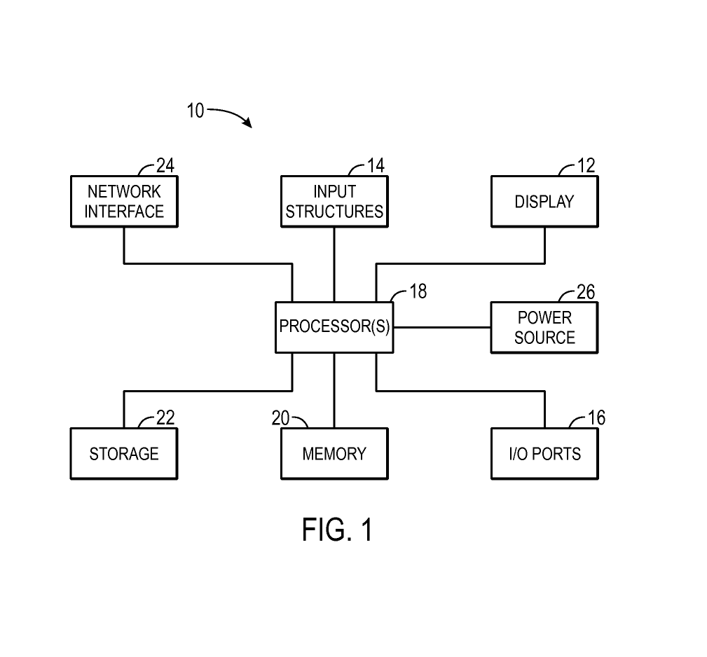

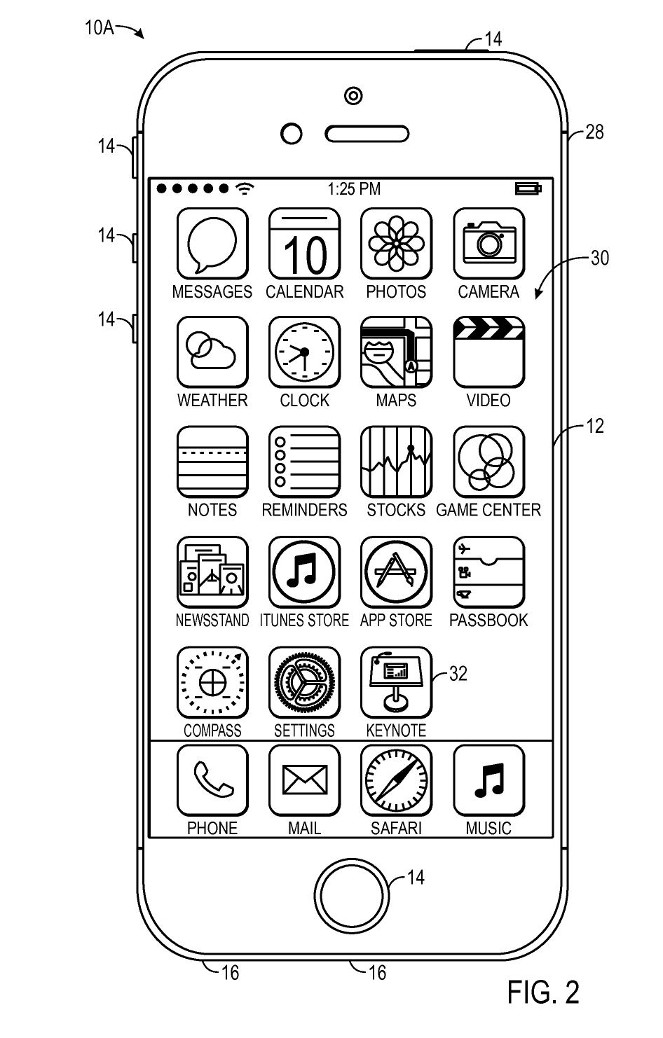

A variety of suitable electronic devices may employ the techniques described herein. FIG. 1, for example, is a block diagram depicting various components that may be present in a suitable electronic device 10. FIGS. 2, 3, and 4 illustrate example embodiments of the electronic device 10, depicting a handheld electronic device, a tablet computing device, and a notebook computer, respectively.

Turning first to FIG. 1, the electronic device 10 may include, among other things, a display 12, input structures 14, input/output (I/O) ports 16, one or more processor(s) 18, memory 20, nonvolatile storage 22, a network interface 24, and a power source 26. The various functional blocks shown in FIG. 1 may include hardware elements (including circuitry), software elements (including computer code stored on a non-transitory computer-readable medium) or a combination of both hardware and software elements. It should be noted that FIG. 1 is merely one example of a particular implementation and is intended to illustrate the types of components that may be present in the electronic device 10. Indeed, the various depicted components (e.g., the processor(s) 18) may be separate components, components of a single contained module (e.g., a system-on-a-chip device), or may be incorporated wholly or partially within any of the other elements within the electronic device 10. The components depicted in FIG. 1 may be embodied wholly or in part as machine-readable instructions (e.g., software or firmware), hardware, or any combination thereof.

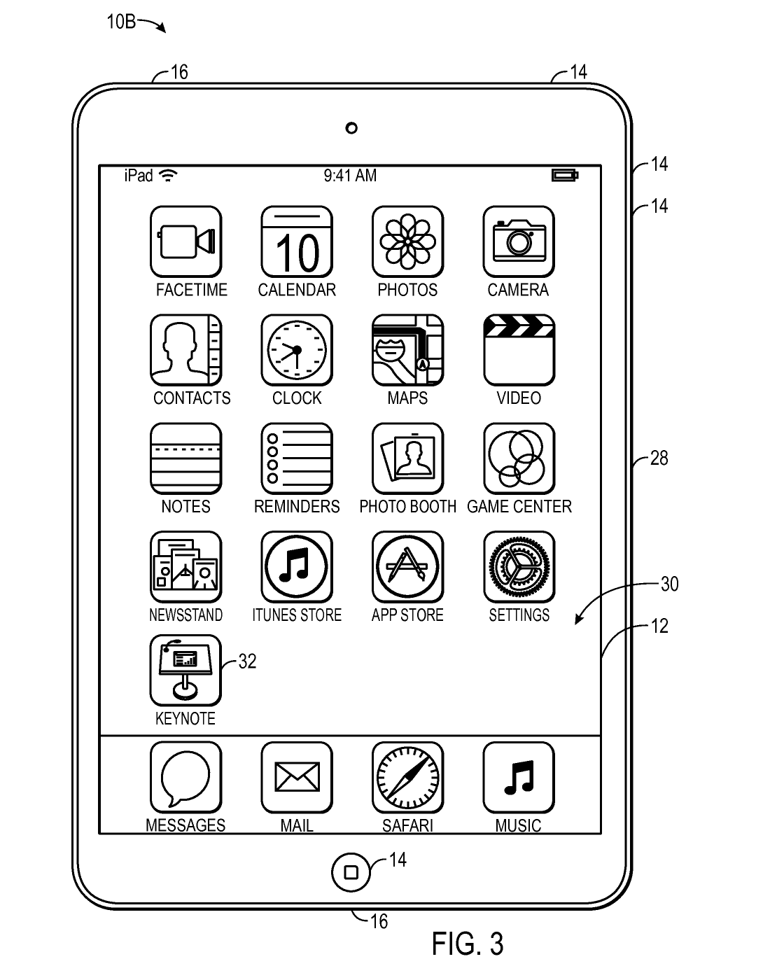

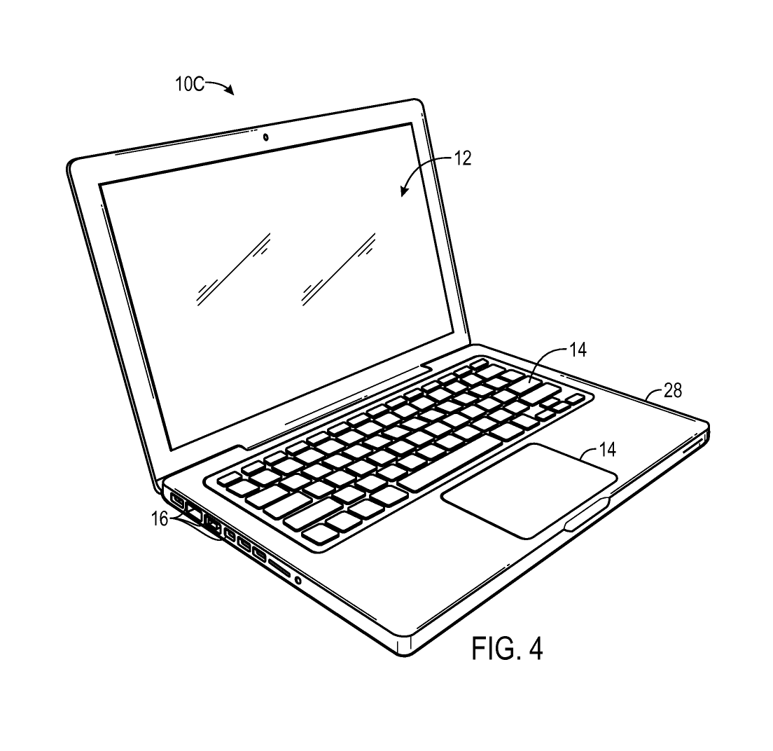

By way of example, the electronic device 10 may represent a block diagram of the handheld device depicted in FIG. 2, the tablet computing device depicted in FIG. 3, the notebook computer depicted in FIG. 4, or similar devices, such as desktop computers, televisions, and so forth. In the electronic device 10 of FIG. 1, the display 12 may be any suitable electronic display used to display image data (e.g., a liquid crystal display (LCD) or an organic light emitting diode (OLED) display). In some examples, the display 12 may represent one of the input structures 14, enabling users to interact with a user interface of the electronic device 10. In some embodiments, the electronic display 12 may be a MultiTouch™ display that can detect multiple touches at once. Other input structures 14 of the electronic device 10 may include buttons, keyboards, mice, trackpads, and the like. The I/O ports 16 may enable electronic device 10 to interface with various other electronic devices.

The processor(s) 18 and/or other data processing circuitry may execute instructions and/or operate on data stored in the memory 20 and/or nonvolatile storage 22. The memory 20 and the nonvolatile storage 22 may be any suitable articles of manufacture that include tangible, non-transitory computer-readable media to store the instructions or data, such as random-access memory, read-only memory, rewritable flash memory, hard drives, and optical discs. By way of example, a computer program product containing the instructions may include an operating system (e.g., OS X® or iOS by Apple Inc.) or an application program (e.g., Keynote® by Apple Inc.).

The network interface 24 may include, for example, one or more interfaces for a personal area network (PAN), such as a Bluetooth network, for a local area network (LAN), such as an 802.11x Wi-Fi network, and/or for a wide area network (WAN), such as a 4G or LTE cellular network. The power source 26 of the electronic device 10 may be any suitable source of energy, such as a rechargeable lithium polymer (Li-poly) battery and/or an alternating current (AC) power converter.

As mentioned above, the electronic device 10 may take the form of a computer or other type of electronic device. Such computers may include computers that are generally portable (such as laptop, notebook, and tablet computers) as well as computers that are generally used in one place (such as conventional desktop computers, workstations and/or servers). FIG. 2 depicts a front view of a handheld device 10A, which represents one embodiment of the electronic device 10. The handheld device 10A may represent, for example, a portable phone, a media player, a personal data organizer, a handheld game platform, or any combination of such devices. By way of example, the handheld device 10A may be a model of an iPod® or iPhone® available from Apple Inc. of Cupertino, Calif.

The handheld device 10A may include an enclosure 28 to protect interior components from physical damage and to shield them from electromagnetic interference. The enclosure 28 may surround the display 12, which may display a graphical user interface (GUI) 30 having an array of icons 32. By way of example, one of the icons 32 may launch a presentation application program (e.g., Keynote® by Apple Inc.). User input structures 14, in combination with the display 12, may allow a user to control the handheld device 10A. For example, the input structures 14 may activate or deactivate the handheld device 10A, navigate a user interface to a home screen, navigate a user interface to a user-configurable application screen, activate a voice-recognition feature, provide volume control, and toggle between vibrate and ring modes. Touchscreen features of the display 12 of the handheld device 10A may provide a simplified approach to controlling the presentation application program. The handheld device 10A may include I/O ports 16 that open through the enclosure 28. These I/O ports 16 may include, for example, an audio jack and/or a Lightning® port from Apple Inc. to connect to external devices. The electronic device 10 may also be a tablet device 10B, as illustrated in FIG. 3. For example, the tablet device 10B may be a model of an iPad® available from Apple Inc.

In certain embodiments, the electronic device 10 may take the form of a computer, such as a model of a MacBook®, MacBook® Pro, MacBook Air®, iMac®, Mac® mini, or Mac Pro® available from Apple Inc. By way of example, the electronic device 10, taking the form of a notebook computer 10C, is illustrated in FIG. 4 in accordance with one embodiment of the present disclosure. The depicted computer 10C may include a display 12, input structures 14, I/O ports 16, and a housing 28. In one embodiment, the input structures 14 (e.g., a keyboard and/or touchpad) may be used to interact with the computer 10C, such as to start, control, or operate a GUI or applications (e.g., Keynote® by Apple Inc.) running on the computer 10C.

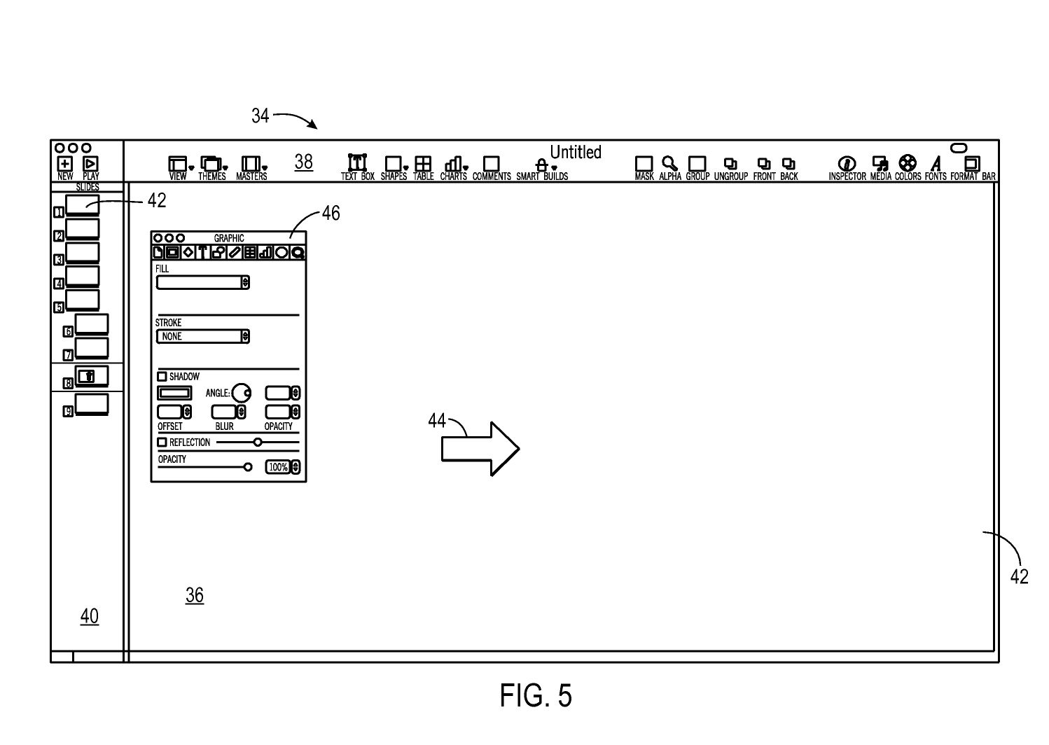

With the preceding in mind, a variety of computer program products, such as applications or operating systems, may use the techniques discussed below to enhance the user experience on the electronic device 10. Indeed, any suitable computer program product that includes a canvas for displaying and/or editing shapes or images may employ some or all of the techniques discussed below. For instance, the electronic device 10 may run a presentation program 34 (e.g., Keynote® from Apple Inc.) as shown in FIG. 5. The presentation application 34 shown in FIG. 5 may provide multiple modes of operation, such as an edit mode and a presentation mode. In FIG. 5, the presentation application 34 is shown in the edit mode. In the edit mode, the presentation application may provide a convenient and user-friendly interface for a user to add, edit, remove, or otherwise modify the slides of a slide show. To this end, the presentation program 34 may include three panes: a canvas 36, a toolbar 38, and a slide organizer 40. The canvas 36 may display a currently selected slide 42 from among the slide organizer 40. A user may add content to the canvas 36 using tool selections from the toolbar 38. Among other things, this content may include objects 44 such as text boxes, images, shapes, and/or video objects.

As used herein, a “slide” should be understood to refer to a discrete unit of an ordered or sequential presentation. Such a slide, therefore, may be understood to function as a container for a set of objects (as discussed below) that together convey information about a topic of a presentation. For example, each slide may contain or include different types of objects that explain or describe a concept to which the slide is directed.

Further, as used herein, the term “text character” may be understood to refer to any discretely editable text component on a slide of a presentation. That is, any object or character used as text that can be added to a slide and/or be altered or edited on the slide, such as to change its location, orientation, font, color, or size may be described as a text character. Text characters may include, but are not limited to, letter and number characters, as well as punctuation characters, symbol characters (e.g., an ampersand “&”, a dollar sign “$”, an asterisk “*”, and so forth). For example, a single letter or a single number may constitute a text character as used herein, while a string of such text characters may constitute a text string.

In addition, as discussed herein, the present approaches may more generally be applied to any arbitrary shape having one or both of the interior or exterior border clearly defined and whose color data can be removed or factored out. Because a slide may contain multiple text characters or shapes of this type, a slide may have an associated z-ordering of those text characters and shapes, as well as other displayed objects, as they are displayed on the slide. That is, to the extent that objects, including text characters and shapes, on the slide may overlap or interact with one another, they may be ordered or layered with respect to a viewer such that some objects are on top of or beneath other objects as they appear on the slide. In this way, a slide may not only have a width and length associated with it, but also a depth.

When in the edit mode, the user may assign animations or other effects to the text characters on a slide, such as by designing a build for the text characters on the slide that governs the appearance and animation of the text characters when the slide is presented. For example, while a slide is being shown, the text characters on the slide may, in accordance with the build, be animated to appear, disappear, move, or otherwise change appearance in response to automated or user provided cues (such as a mouse click or an automated sequence).

Once the slides of a presentation are designed in the edit mode, the presentation may be played in the presentation mode by displaying one or more slides in sequence for viewing by an audience. In some embodiments, the presentation application may provide a full-screen presentation of the slides in the presentation mode, including any animations, transitions, or other properties defined for each object within the slides.

The order or sequence of the slides in a presentation or slideshow is relevant in that the information on the slides, typically conveyed by text characters and other objects placed on the respective slides, is generally meant to be viewed in a specified order and may build upon itself, such that the information on later slides is understandable in the context of information provided on preceding slides. That is, there is typically a narrative or explanatory flow associated with the ordering or sequence of the slides. As a result, if presented out of order, the information on the slides may be unintelligible or may otherwise fail to properly convey the information contained in the presentation. This should be understood to be in contrast to more simplistic or earlier usages of the term “slide” and “slideshow” where what was typically shown was not a series of multimedia slides containing sequentially ordered content, but projected photos or images which could typically be displayed in any order without loss of information or content.

With the preceding discussion in mind, the depicted example screen shown in FIG. 5 includes three panes: a slide canvas 36, a toolbar 38, and a slide organizer 40 for creating and editing various aspects of a slide of a presentation. With these panes, a user may select a slide of a presentation, add and/or edit the contents of a slide, and animate or add effects related to the contents of a slide. It should be understood that the size of each pane is merely illustrative, and that the relative size of each pane may vary or be adjusted by a user.

The slide organizer 40 may display a representation of each slide of a presentation that is being generated or edited. The slide representations may take on a variety of forms, such as an outline of the text in the slide or a thumbnail image of the slide. The slide organizer 40 may allow the user to organize the slides prepared using the application. For example, the user may determine or manipulate the order in which the slides are presented by dragging a slide representation from one relative position to another. As illustrated in FIG. 5, the slide representations in the slide organizer 40 may be indented or otherwise visually set apart for further organizational clarity.

Selecting a slide representation in the slide organizer 40 may result in the presentation application displaying the corresponding slide (e.g., slide 42) on the canvas 36. The selected slide 42 may include one or more suitable objects 44 such as, for example, text characters, images, graphics, video, or any other suitable object. A user may add or edit features or properties of the selected slide 42 when displayed on the slide canvas 36. For example, a user may edit settings or properties associated with the selected slide 42 (e.g., the slide background or template) on the canvas 36 or may edit the location, orientation, size, properties, and/or animation of objects (e.g., object 44) in the selected slide. The user may select a different slide to be displayed for editing on slide canvas 36 by selecting a different slide representation from the slide organizer 40.

In the depicted implementation, a user may customize objects 44, including text characters or strings, associated with the slide 42 or the properties of the slide 42 using various tools provided by the presentation application 34 in association with the canvas 36. For example, the toolbar 38 may provide various icons that activate respective tools and/or functions that may be used in creating or editing the slide 42. For example, the toolbar 38 may include an icon that, when selected, activates a build tool that allows one or more objects (e.g., shapes, text characters, images, tables, videos, etc.) to be selected and/or grouped. Animations (motion, rotation, changes in size, shading, color, opacity, and so forth) may be generated for such selected objects or groups of objects, including shapes and text objects. In some embodiments, the animations may be rendered in real-time (e.g., using dedicated graphics circuitry, such as a GPU on a video card) when slides containing the animations are displayed or presented as part of a presentation.

In some embodiments, the presentation application 34 may allow a control window 46 to be opened or displayed. The presentation application 34 may display the control window 46 automatically (e.g., based on the presentation application context) or in response to a user instruction (e.g., in response to a user instruction to display options related to one or more selected objects). The control window 46 may be moved, resized, and/or minimized/maximized independently of the panes 36, 38, and 40 (e.g., as an overlaid window). The control window 46 may provide one or more user input mechanisms of any suitable type, such as drop down menus, radio buttons, sliders, and so forth. The options available from control window 46 may vary based on a tool selected in toolbar 38 or by a type of object(s) 44 selected on the slide 42. For example, the control window 46 may provide different respective options if a table, video, graphic, shape, or text is selected on the slide 42 or if no object 44 is selected. In the context of text characters and strings, a corresponding control window 46 may include controls by which an associated font can be designated, a font size specified, the use of emphasis (e.g., italics, bolding, underlining, strikethrough, and so forth) indicated, and so forth. It should be understood that although only one control window 46 is shown in FIG. 5, the presentation application 34 may include any suitable number of control windows 46.

With the preceding discussion in mind, various techniques and algorithms for implementing aspects of the present disclosure using such a presentation application 34 (or other suitable computer application) running on a device 10 having suitable hardware and memory devices are discussed below.

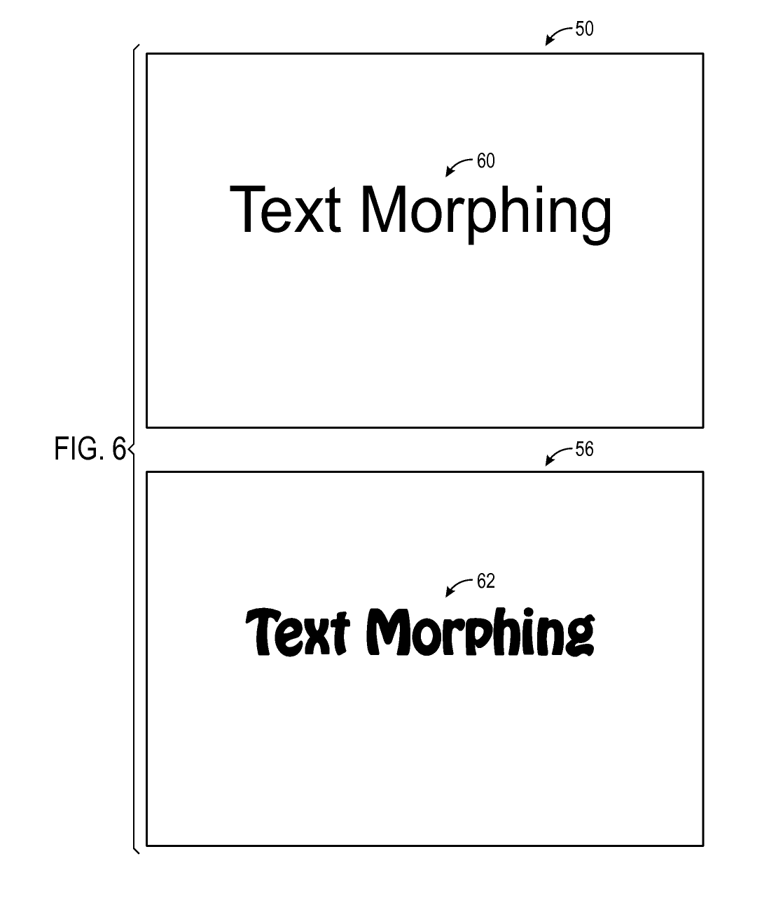

Turning to FIG. 6, an example of an outgoing slide 50 is depicted. Such an outgoing slide 50 is typically a discrete unit of a presentation (e.g., a slideshow presentation) that typically includes multiple slides that are sequentially displayed. In such an example, an outgoing slide 50 represents a slide that is being displayed at the beginning of a slide transition and which will be transitioned off of the display as an incoming slide 56 is transitioned on to the display.

As discussed herein, in one embodiment a string of outgoing text 60 provided on the slides of a presentation is identified, automatically or by a user, allowing each character of outgoing text 60 to be independently manipulated, such as animated, when transitioning between slides. That is, for a slide being transitioned out (i.e., an outgoing slide 50), each character of outgoing text 60 may be separately handled, so that different text characters may be differently animated as part of the transition.

In certain embodiments, a transition between slides may take into account whether a character or character string of outgoing text 60 present on the outgoing slide 50 has a match on the incoming slide 56. By way of example, a character of the outgoing text 60 on an outgoing slide 50 that is determined to be matched to a character of incoming text 62 on an incoming slide 56 may be animated differently during a transition than outgoing text 60 or incoming text 62 present only on one of the outgoing or incoming slide 50 and 56. For example, a text character on the outgoing slide 50 that is matched to a text character on the incoming slide 56 may continue to be displayed during the slide transition, with some animation or text morphing effect or effects applied to transition the text character from how it appears on the outgoing slide 50 to how it appears on the incoming slide 56. Conversely, text characters present on only one of the outgoing or incoming slide 50, 56 will typically be displayed for a portion of the slide transition, such as to animate the text character on to (i.e., to introduce the text character) or off of (i.e., to remove the text character) the display. Thus, in one implementation, a text character may be matched to a corresponding text character in a subsequent slide (though it may be in different locations, orientations, fonts, or at a different scale in the two slides) and a text morph may be applied to the text character such that the text character appears to move, turn, resize, and so forth to reach the appropriate size, font, location, and/or orientation in the incoming slide after the transition.

As discussed herein, the identification and matching of outgoing text 60 and incoming text 62 may be performed automatically in accordance with one or more matching algorithms. By way of example, in one embodiment outgoing and incoming text 60, 62 may be matched (or not matched) on an outgoing slide 50 and incoming slide 56 based upon optimization of a mathematical matching function (e.g., a cost function), such as by minimization or maximization of the matching function. In practice, a matching function used to match objects on two or more slides may be specific to the types of objects under consideration. For example, such functions may be implemented so that text characters may be matched only with other text characters. That is, in such an implementation, an outgoing text character (or string) may only be matched with another incoming text character (or string), rather than the outgoing text character being matched with an image input of a similar shape but which is of a different object class.

Factors that may be considered in such a matching function include, but are not limited to: location differences, scale differences, rotation differences, differences in shape, differences in color or fill, differences in texture, differences in character strings, differences in font, font size or emphasis, and text character color in the context of text character strings, and so forth. These and other factors, typically properties of the text characters in question, may all contribute to the determination as to whether two text characters on sequential slides are matched with respect to the matching function.

Additionally, in another embodiment, outgoing and incoming text 60, 62 may be matched (or not matched) on an outgoing slide 50 and incoming slide 56 based upon ASCII or other text character input codes representing various text characters for the outgoing and incoming text 60, 62. In such an implementation, the text character input code of the outgoing text 60 on the outgoing slide 50 may be compared to the text character input code of the incoming text 62 on the incoming slide 56 in order to determine text character matches. For example, a text character ‘T’ may be analyzed by its associated ASCII character code on the outgoing slide 50 and the incoming slide 56. A match may be determined based on the ASCII character code regardless of the text character ‘T’s size, font, location, etc.

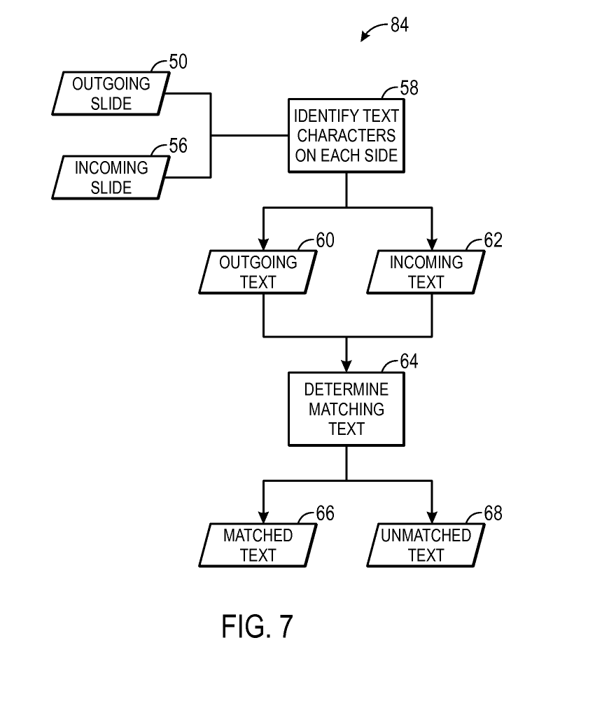

The above approaches may be summarized as control logic which may be implemented as a matching algorithm 84, shown in FIG. 7 that may be stored as a processor-executable routine on a suitable storage medium and implemented as a function of a presentation application, as discussed herein. In accordance with one such algorithm, text characters are identified (block 58) from both outgoing slide 50 and incoming slide 56. Based on this identification operation, a set of outgoing text 60 and incoming text 62 are identified. Based on a matching function, a match may be determined (block 64) for each character of eligible incoming and outgoing text 62, 60. As noted above, in some embodiments, a given text character may itself influence or modify the matching function based on the text character's input code or other properties defined for that character.

For a given set of eligible incoming and outgoing text 62, 60 associated with a given matching function, the respective matches may be analyzed. Pairs of incoming and outgoing text 62, 60 having met a determined threshold of matching characteristics may be deemed matched text 66. Conversely, incoming and outgoing text 62, 60 for which no match is determined may be deemed unmatched text 68 and handled differently than the matched text 66 during slide transitions.

Additionally, in the context of outgoing and incoming text 60, 62 where there are text character strings (i.e., words or groups of words with multiple text characters), the text character string may be matched at least partly based on the string content (i.e., the sequence of text characters forming each string), with each character in a string itself being a discrete and separate unit that may be evaluated and morphed independently. Therefore, it may be desirable to at least partly take into account the degree of overlap or similarity between character strings when determining matches. In certain embodiments, evaluation of a text character string may include evaluation of sub-strings from which the larger strings are composed.

For example, a text character string may be present on an outgoing slide 50 and a related, but partially overlapping text character string may be present on the incoming slide 56. In one example, the text character string “chance of rain” may be present on the outgoing slide 50 and the text character string “chance of precipitation” may be present on the incoming slide 56. As will be appreciated, the character strings “chance of rain” and “chance of precipitation” are not identical, though portions of the respective strings are the same.

However, as part of the matching process, substrings within each string may be compared. For example, each of the text character strings in this example have the text character substring “chance of” in common, in addition to related text character substrings contained within this substring (e.g., “chance”, “of”, “chan”, “ance of” and so forth). In practice it may be desirable to utilize the match that has matching characters and which is also the longest. For example, while the text character substrings “chance of”, “chance”, and “of” on subsequent slides may all be associated with a number of matching text characters, the text character substring “chance of” may be accepted as the match as being the longest text character substring. As will be appreciated, text character matching may occur down to the level of individual characters, such that, if no strings of two or more characters are matched, individual characters may still be matched as being present on both the outgoing slide 50 and incoming slide 56 and handled individually with respect to the transition and animation. That is, individual text characters may be displayed and animated during the transition so that they remain on the screen, merely being animated to a new font, location, or orientation if needed.

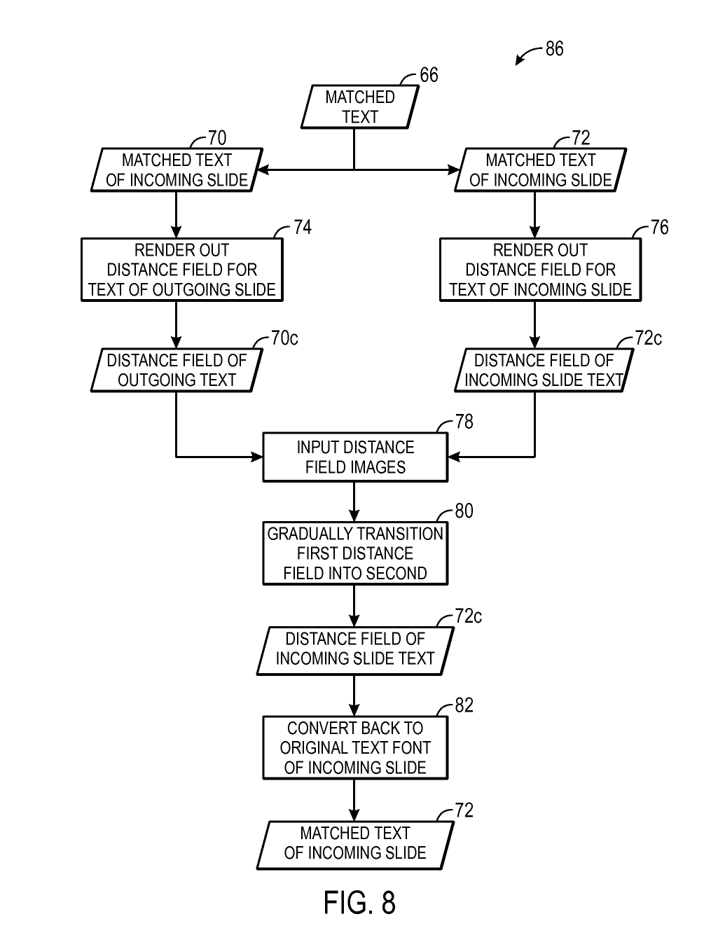

While the preceding relates to approaches for matching outgoing and incoming text 60, 62 on sequential slides by optimizing a matching function, the actual process of morphing the matched text 66 has not yet been discussed. Turning to FIG. 8, an additional processor-executable algorithm 86 is depicted in which matched text 70 of the outgoing slide is morphed into matched text 72 of the incoming slide. In the present embodiment, matched text 70 and matched text 72 are rendered (blocks 74 and 76) into their respective distance fields 70c and 72c. Once distance fields 70c and 72c are rendered, the two distance fields 70c, 72c are combined (block 78) to begin a text morph process. The text morph process is accomplished by gradually transitioning (block 80) distance field 70c into distance field 72c. When the text morph process is complete, distance field 72c is converted (block 82) back to the original matched text 72.

The text morph process is accomplished by rendering out the distance fields 70c, 72c of the matched text 70, 72. Distance fields, also known as distance transforms and distance maps, are representations of digital images where each pixel of the digital image is assigned a distance vector to a nearest obstacle pixel. The nearest obstacle pixel is represented by the closest background pixel to an individual pixel in the foreground of the image. For example, each pixel of a text character would have a distance vector assigned to it, the distance vector representing how far the closest pixel of the text character border is from the pixel of the text character. The resulting images of the distance fields 70c, 72c, when combined, create a blended distance field and allow for a smooth and gradual morphing between differing text fonts, sizes, and/or emphases of the matched text 70, 72. The morphing between the matched text 70, 72 may be displayed during a slide transition or during other operations in which a smooth transition from one text string to another is desired.

In some embodiments, a smooth text morph process might also utilize a transform function in the text morphing process discussed above using distance fields. For example, matched text 70 and 72 may appear differently on the outgoing slide 50 and the incoming slide 56 by one or more of rotation, scaling, or location in such a manner that text morphing alone will not provide the desired transitional effect. These differences may be transitioned between using a basic transform function to improve the appearance of the text morph process. For example, in certain embodiments, the matched text 70 and 72 on the outgoing slide 50 and incoming slide 56 may have object properties that differ in text rotation. In this embodiment, text matches may be transitioned from how the matched text 70 appears on the outgoing slide 50 to how the rotated matched text 72 appears on the incoming slide 56 by using a basic transform function to compensate for the rotation prior to morphing the matched text using the distance field. Additionally, the transform function that compensates for the matched text differences may be applied to the distance fields 70c and 72c where a transform function compensation effect occurs gradually during the text morphing process resulting in a smooth transition.

Additionally, because the distance fields operate on the morphology of the text characters, color is not considered in the morph process and may instead be handled separately from the morphing process. That is, in the morphing process, only the inside of the character's shape or the outside of the character's shape (i.e., the morphology of the shape or character) are considered. In order to conduct a color transition from one slide to the next, the color transition can be applied separately, such as after a text morphing process is completed. In one embodiment, because the distance fields do not take color into account, the distance fields function in gray-scale. Therefore, shape based text styles can be transitioned between using the text morph process, but non-shape based text styles (i.e., color) may instead be added separately from the text morphing process. Thus, when the distance fields are created, the non-shape text styles (i.e., color) can be separated from matched text 70 and matched text 72. In such an instance, a gradual change in color from a color of matched text 70 to a color of matched text 72 may be blended into the text morph during the slide transition.

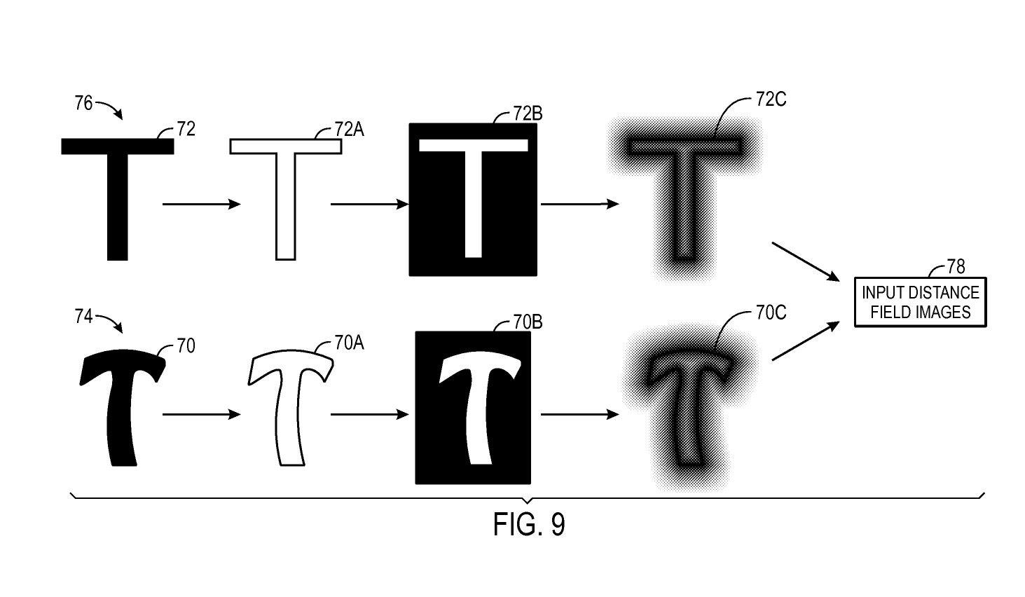

Turning to FIG. 9, the process of blocks 74 and 76, which render the distance fields for matched text 70 and 72, is shown in more detail. Initially, the matching text 70 of the outgoing slide 50 is shown. The matching text 70 is converted to gray-scale, and an outline 70a of matching text 70 is created. Subsequently, an inverse 70b of the matching text 70 is created from the outline 70a. An outer portion of a signed distance field 70c of matched text 70 is created from the inverse 70b by assigning and representing a distance vector of each dark pixel to the nearest border pixel. Additionally, an inner portion of signed distance field 70c is created by assigning and representing a distance vector of each dark pixel of the matched text 70 to the nearest border pixel. The signed distance field 70c displays the distance vector of each pixel by varying the shade of the pixels. The distance vectors representing the inside of matching text 70 may also be represented by one color, while the distance vectors representing the outside of matching text 70 may be represented by another color. A darker pixel of each respective color may represent a pixel close to a border pixel, while a lighter pixel of each respective color may represent a pixel far from a border pixel. Conversely, a darker color may represent a pixel far from the border while a lighter color may represent a pixel close to the border. This same process is repeated for matched text 72 of the incoming slide 56 creating an outline 72a of matched text 72, an inverse 72b of outline 72a, and a signed distance field 72c of matched text 72 from the inverse 72b (representing an outer portion of signed distance field 72c) and matched text 72 (representing an inner portion of signed distance field 72c). Once the signed distance fields 70c and 72c are generated, the signed distance fields 70c, 72c are provided as inputs (block 78) to a gradual text morphing process.

In one embodiment, after the distance fields 70c and 72c are created, an algorithm may be implemented that gradually changes distance field 70c into distance field 72c. During this conversion, a morphing of the distance fields 70c and 72c is sampled at a set frame rate. Samples representing the morphing of the distance fields are created through this sampling process. The samples are then converted into a number of transitional text representations, which represent the gradual effects of the morphing on the matched text. The transitional text representations may be displayed sequentially during the slide transition. Such a display may result in a smooth transition between text styles on subsequent slides.

Further, in one embodiment, though the display of transitional text representations may appear to display a morphing of an entire string of text characters all at once, the text morphing process may actually takes place on the individual text characters one at a time or on the entire string all at once. For example, a ‘T’ represented in FIG. 9 as matching text 70 and 72 may represent a first character of a string of text such as the term “Text Morph.” Multiple text morphs may be displayed simultaneously during the slide transition, but individual text morphs may be created separately prior to display. This also indicates that in some situations the text morphing process of a matching character string between two slides may have several individual text characters morph, while other text characters, which do not have any style variations between the two slides, might simply remain as they appear on an outgoing slide during the slide transition. Likewise, unmatched characters may be removed from or added to view (such as by fading in or out or by sliding off or on screen) as part of such a transition.

In another embodiment, a matching text character pair might not provide a smooth transition using a distance field text morphing process and/or a transform function compensation as discussed above. A morphing of the matching text character pair that does not provide a smooth transition may be referred to as non-ideal morphing, while a morphing that does provide a smooth transition may be referred to as ideal. This non-ideal morphing situation might occur when one of the two matching text characters is italicized or is otherwise stylized to distort the base character shape. For example, an italicized letter adds a slant to whichever font a text character is presented in. This slant creates a situation where in the distance field text morphing process, a non-italicized letter of an outgoing slide would disappear and reappear as it transitions to an italicized letter of an incoming slide. Generally, in order to remedy this effect, a transform may be constructed in order to map an incoming distance field most closely to an outgoing distance field. In another embodiment, a rough skeleton of both letters may be created, and a transform applied to both skeletons in order to create a more natural alignment between the two text characters. The rough skeleton of a letter may be an approximation of a letter's distance field to provide a general shape that will ultimately be populated by the actual distance field. Providing a transform of the two skeletons may ultimately allow the distance fields of the letters to more closely align, which may result in a smoother slide transition than would otherwise be available. In a situation involving a non-italicized outgoing letter and an italicized incoming letter, both skeletons might be rotated towards each other until the two skeletons are substantially aligned. Once an appropriate alignment is created, the two letters can begin the text morphing process as discussed above. The text morphing process may also occur when the rough skeleton of an italicized incoming character is transformed to align with the rough skeleton of an outgoing character. The text morphing process may then proceed where a transitional representation of the morphing process is gradually rotated to the italicized incoming character's original position.

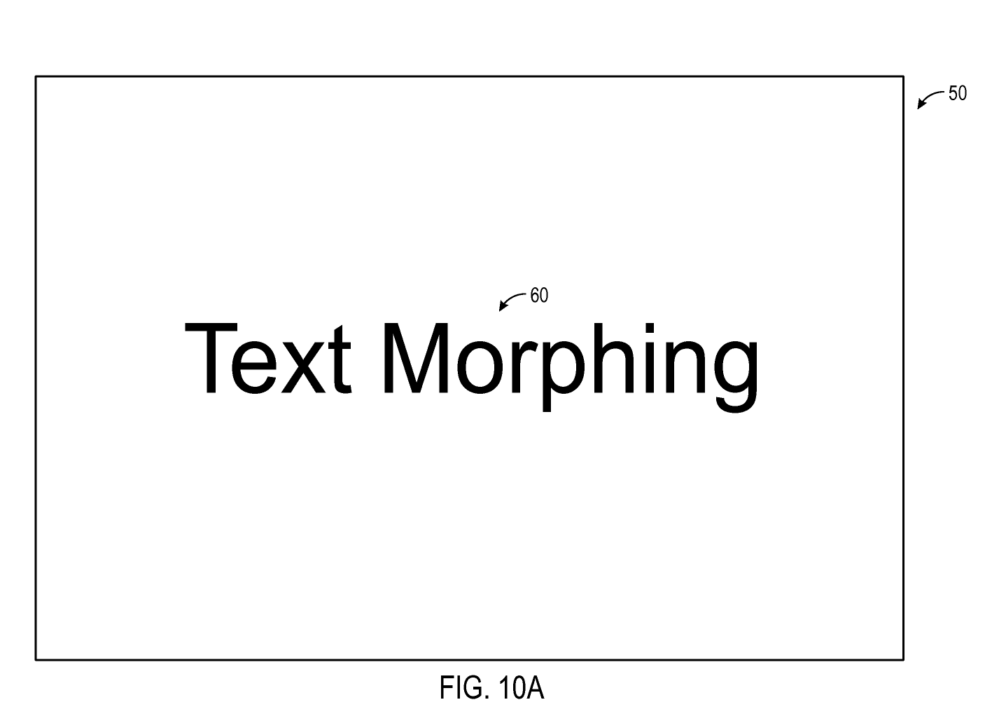

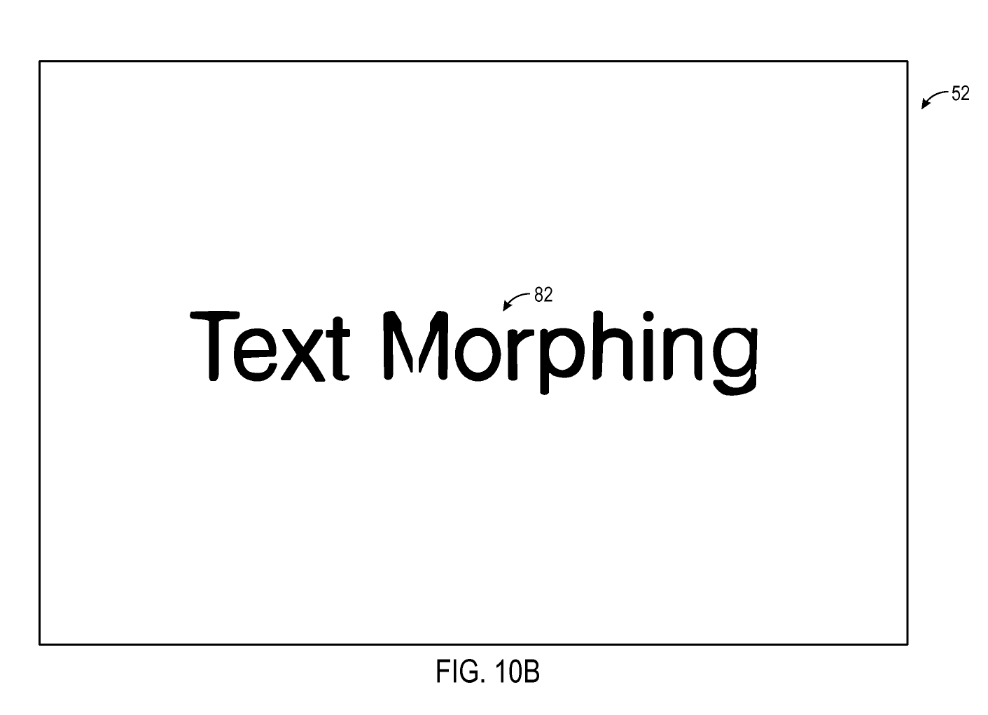

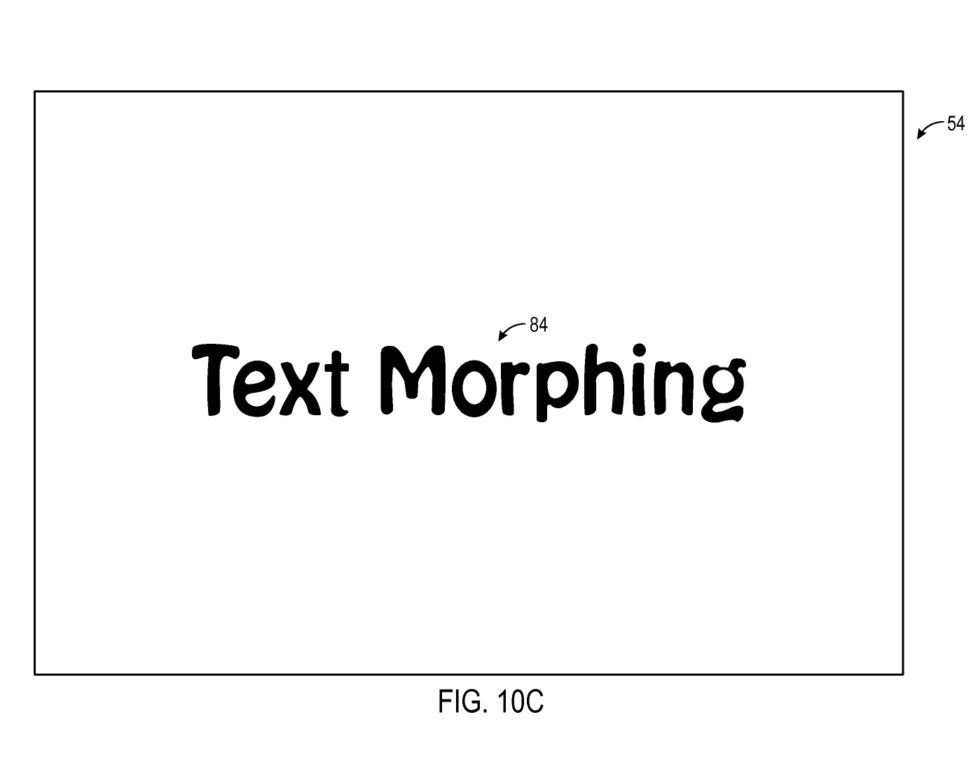

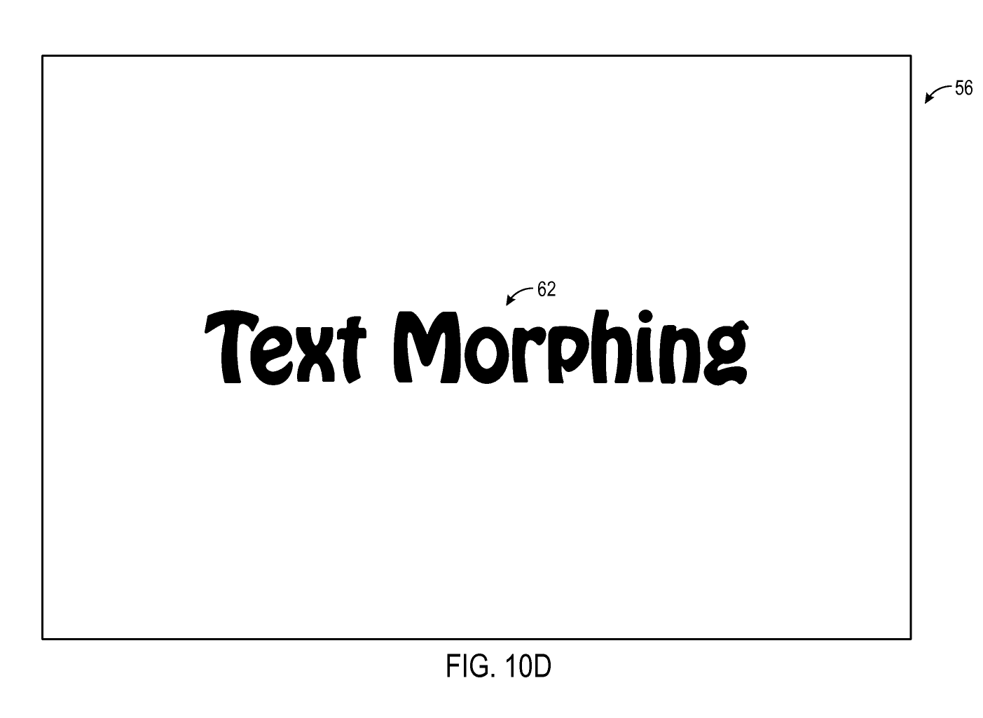

Turning now to FIG. 10, during a text morphing process, a morph is displayed in a presentation as an outgoing slide 50 transitions to an incoming slide 56. Outgoing text 60 and outgoing slide 50 are displayed in FIG. 10a. FIG. 10b shows a transitional frame 52 displaying a transitional text representation 82. FIG. 10c shows an additional transition frame 54 displaying a transitional text representation 84, which in this embodiment represents a further transitional state in the text morphing process. Finally, FIG. 10d shows the incoming slide 56 displaying incoming text 62, which is fully morphed. The sequence of slides and transitional frames 50, 52, 54, 56 observed in sequential order represent a full slide transition using the text morphing process described in detail above.

While the preceding discussion has focused on several examples specific to characters and characters strings (e.g., text and text strings), it should be appreciated that as used herein, a character is understood to be any arbitrary shape having a clearly-defined interior or exterior and whose color data is removable or separable, which may include a text character. Likewise, a string may be a string of any such characters. Thus, it should be understood that examples included herein related to the morphing of text-type characters are merely intended to facilitate explanation of the present approach, and that the present approach should be understood to be more generally applicable to all suitable characters, including arbitrary shapes having sufficiently defined interior or exterior bounds.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. A non-transitory, tangible computer-readable medium having instructions stored thereon, wherein the instructions, when executed by a processor cause acts to be performed comprising:
analyzing an outgoing slide and an incoming slide of a slideshow presentation to identify one or more text characters on each of the outgoing slide and the incoming slide;
performing a matching operation on the identified text characters to identify one or more pairs of matched text characters, each matched text character pair comprising a matched text character on the outgoing slide and a corresponding matched text character on the incoming slide;
determining whether the matched text character on the outgoing slide and the corresponding matched text character on the incoming slide differ in character style;
creating a distance field of an outline of the matched text character on the outgoing slide and a distance field of the corresponding matched text character on the incoming slide upon a finding of a difference in character style; and
gradually morphing the distance field of the outline of the matched text character of the outgoing slide to the distance field of the outline of the corresponding matched text character on the incoming slide to generate a transitional animation that is executed when transitioning from the outgoing slide to the incoming slide.

2. The non-transitory, tangible computer-readable medium of claim 1, wherein determining the one or more pairs of matched text characters comprises a comparison of text characters on the outgoing and incoming slides based on text character shape.

3. The non-transitory, tangible computer-readable medium of claim 1, wherein determining the one or more pairs of matched text characters comprises reading and comparing a character code input of each text character on each of the outgoing and incoming slides.

4. The non-transitory, tangible computer-readable medium of claim 1, wherein the matching operation comprises comparing one or more strings of text characters and a threshold number of sequential characters is considered a match.

5. The non-transitory, tangible computer-readable medium of claim 4, wherein a pair of matching strings of text characters is morphed by separately morphing pairs of matched text characters within the respective matching strings.

6. The non-transitory, tangible computer-readable medium of claim 1, wherein gradually morphing the distance field of the outline of the first matched text character to the distance field of the outline of the corresponding matched text character further comprises:
sampling a morphing of the distance fields at a set frame rate;
converting a plurality of sampled morphings to a plurality of transitional text representations; and
displaying the plurality of transitional text representations sequentially during a slide transition.

7. The non-transitory, tangible computer-readable medium of claim 6, wherein a display of transitional text representations further comprises a display of a color style conversion from the matched text character of the first slide to the matched text character of the second slide.

8. The non-transitory, tangible computer-readable medium of claim 7, wherein the color style conversion occurs separately from morphing the distance field of the outline of the matched text character of the first slide to the distance field of the outline of the corresponding matched text character of the second slide.

9. The non-transitory, tangible computer-readable medium of claim 1, further comprising a slide transition morphing for a difference between the matched text character of the first slide and the matched text character of the second slide using a transform function to compensate for a difference in rotation, scale, or location.

10. The non-transitory, tangible computer-readable medium of claim 1, further comprising:
determining if a morph of matching text characters is ideal or non-ideal;
creating a rough skeleton of the matching text characters upon determining that the morph is non-ideal;
using a transform function to further align the rough skeletons;
gradually morphing a realigned distance field of the outline of the matched text character of the outgoing slide to a realigned distance field of the outline of the corresponding matched text character of the incoming slide; and
using a transform function to return the corresponding matched text character of the incoming slide to an original incoming slide position.

11. A processor-implemented method for morphing text or shapes displayed on a pair of sequential slides, comprising:
matching a plurality of text or shape characters on a first slide and a second slide of a slideshow implemented using a presentation application;
creating a pair of distance fields from a pair of outlines of a pair of matching text or shape characters;
generating a transition morph that animates a transition from the matching text or shape characters on the first slide to the corresponding matching text or shape characters on the second slide when the first slide transitions to the second slide during the slideshow, wherein the transition morph for each pair of matching text or shape characters is determined at least in part by morphing the pair of distance fields.

12. The processor-implemented method of claim 11, further comprising:
determining a difference between one or more matching text or shape characters based on a transform function; and
generating the transition morph, wherein the transition morph is determined at least in part by accounting for the difference between one or more matching text or shape characters based on the transform function.

13. The processor-implemented method of claim 11, wherein the transition morph for an exact match of text or shape characters comprises maintaining the text or text as it appears on the first slide when transitioning to the second slide.

14. The processor-implemented method of claim 11, wherein the transition morph between a non-ideal pair of matching characters is accomplished by constructing a text or shape character skeleton for each of the matching text or shape characters and applying a transform to rotate both of the text or shape character skeletons to an ideal position prior to morphing the pair of distance fields.

15. A processor-based system, comprising:
a display;
a memory storing one or more instructions; and
a processing component configured to execute the one or more instructions stored in the memory, wherein the one or more instructions, when executed by the processing component, cause acts to be performed comprising:
within a slideshow generated by a presentation application, determining one or more matched character pairs for a plurality of characters present on a first slide and a second slide of the slideshow;
generating a transitional animation for each matched character pair using distance fields of an outline of each matched character that gradually transitions the distance field of the outline of the matched character in a first slide to the distance field of the outline of the matched character of a second slide.

16. The processor-based system of claim 15, wherein one or more matched character pairs can be determined either by character shape or by a character input code.

17. The processor-based system of claim 15, wherein the one or more matched character pairs may be limited by requiring a threshold number of sequential characters in a character string on the first and second slides to be matching in order for the matched character pairs to be considered matching.

18. The processor-based system of claim 15, wherein the one or more instructions, when executed by the processing component, cause further acts to be performed comprising categorizing each of the matched characters by whether or not the animation will function ideally using a distance field animation and providing an alternate transitional animation for the matched character pair when the distance field animation is non-ideal.

19. The processor-based system of claim 15, wherein the plurality of characters comprises one or both of text characters and arbitrary shapes.

20. A processor-implemented method for morphing a pair of matching text characters displayed on a pair of sequential slides, comprising:
receiving as an input a plurality of matched text character pairs corresponding to matched text characters present on an outgoing and incoming slide;
creating distance fields from outlines of the matched text character pairs; and
based upon the differences in the distance fields of the outlines of the matched text character pairs, generating a transitional text morph for each matched text character.

21. The processor-implemented method of claim 20, wherein the transitional text morph comprises:
morphing from the distance field of a first matched text character to the distance field of a second matched text character;
sampling a morphing of the distance fields at a set frame rate;
converting a plurality of sampled morphings to a plurality of transitional text representations; and
displaying the plurality of transitional text representations during a slide transition.

22. The processor-implemented method of claim 21, wherein the transitional text morph further comprises:
a matching text color transition, wherein the matching text color transition is created after morphing the distance fields and is overlaid on a display of the plurality of transitional text representations.

23. A non-transitory, tangible computer-readable medium encoding processor-executable instructions, wherein the instructions, when executed by a processor cause acts to be performed comprising:
generating a respective transitional text morph for each matched text character pair identified for an outgoing slide and an incoming slide, wherein each respective transitional text morph is created at least in part by a distance field created from a pair of outlines of the matched text character pair; and
executing the transitional text morph when transitioning from the outgoing slide to the incoming slide.

24. The non-transitory, tangible computer-readable medium of claim 23, wherein the matched text character pairs comprise a pair of text characters sharing a same letter, number or symbol representation but having varying character styles.

25. The non-transitory, tangible computer-readable medium of claim 23, further comprising:
generating the matched text character pairs for the outgoing slide and the incoming slide by comparing a text character shape or an input character code of a plurality of text characters in an outgoing slide and an incoming slide.

26. The non-transitory, tangible computer-readable medium of claim 23, wherein the transitional text morph of a matching string of characters occurs one character at a time.
